(19) United States
(12) Patent Application Publication
(10) Pub. No.: US 2001/0038787 A1
(43) Pub. Date: Nov. 8, 2001

(54) Access ramp

(76) Inventors: Adam Beck, West Midlands (GB); David Phillips, West Midlands (GB)

Correspondence Address: Groover & Associates, p.c., Suite 230, 17000 Preston Road, Dallas, TX, 75248, US

(21) Appl. No.: 09/794,636

(22) Filed: Feb. 27, 2001

Related U.S. Application Data
(63) Continuation of application No. PCT/GB99/02821, filed on Aug. 26, 1999.

(30) Foreign Application Priority Data
Aug. 28, 1998 (GB) 9818781.8

(51) Int. Cl. B60P 1/00; B65F 1/00

(52) U.S. Cl. 414/537

(57) ABSTRACT

A ramp (2) to give wheelchair access to a bus (4) comprises a raisable and lowerable platform (26) pivotably mounted on a supporting frame (14) and a further platform (28) extensible beyond a front end (32) of the platform (26) and retractable relative to that platform. A fluid pressure operated piston and cylinder unit (58) below the ramp is arranged to act between the platforms to extend and retract the platform (28) along a line of action A. The unit (58) acts along a line of action B which is transverse to line A. The supporting frame (14) is U-shaped with horizontal open ended slots (82 and 84) at the front ends of its arms. Similar platform slots are formed in two opposite sides of the platform (26) adjacent its front end (32) and each platform slot coincide with the respective slot (82 or 84) when the platform (26) is in a raised position. When the platform (26) is in that position and the platform (28) is fully retracted lateral flanges (86 and 88) on platform (28) enter the corresponding slot (82 or 84) and the corresponding platform slot in platform (26) so the flanges can rest on the lower sides of the slots (82 and 84) and support the raised and retracted ramp.

This invention concerns an access ramp.

The invention particularly concerns a ramp to be used where an ascent from one level to a higher level has to be made to gain access to a region or area.

The ramp may be used to help persons in wheelchairs, or who have difficulty walking, to board a vehicle which may be a motor vehicle, for example a passenger bus. But the ramp could be used in conjunction with other vehicles to give access thereto under other circumstances.

According to the invention a ramp to give access comprises a raisable and lowerable first platform, a second platform extensible from the first platform beyond an end of the first platform and retractable relative to said first platform, fluid pressure force exerting means arranged to act, under fluid pressure, between the first and second platforms to extend or retract the second platform along a first line of action, and said fluid pressure force exerting means being arranged to act along a second line of action which is transverse to the first line of action.

The fluid pressure force exerting means may comprise a fluid pressure actuated piston and cylinder unit.

With such an arrangement a said force exerting means comprising a fluid pressure actuated piston and cylinder unit, in which the piston stroke is sufficiently long to ensure a full extension of the second platform, can be used, and yet the piston and cylinder unit can be “parked” to occupy only a relatively short portion of the distance travelled by the second platform between a fully extended and a fully retracted position.

The piston and cylinder unit may be pivotably mounted on the platforms.

The length of a stroke of the second platform relative to the first platform along the first line of action corresponding to a full extension or full retraction of the second platform with respect to the first platform is a plurality of times greater than a length dimension along the first line of action occupied by the fluid pressure exerting means in a parked position when the second platform is fully retracted. Said length of the stroke may be more than three times said length dimension.

Preferably the second platform moves relatively to the first platform on bearing means. Aforesaid bearing means between the platform at or adjacent to a side of each platform may comprise at least one linear bearing.

Bearing means at or adjacent to the opposite side of each platform may comprise at least one non-linear bearing which may comprise a roller running on track or rail means.

Aforesaid bearing means between the platforms at or adjacent to a side of each platform may comprise a roller running on track or rail means. The roller may rotate on rolling elements between a roller periphery and its axis of rotation.

The linear bearing may comprise rolling elements.

A fluid pressure supply can supply fluid under pressure to the fluid pressure force exerting means, and pressure sensing means may be provided to observe when the pressure of the fluid supplied to said force exerting means increases to a pressure at least equal to a pre-determined value.

The raisable and lowerable first platform is pivotably mounted on support means, and engaging means being provided to be operable in a retracted position of the second platform to support the platforms in a raised state on said support means.

With such an arrangement, when the ramp is in a raised state with the second platform retracted, the ramp can be supported in the raised state without the need of support derived from any actuation means which may be used to raise or lower the first platform and/or to extend or retract the second platform.

Said engaging means may comprise a member on one of said second platform or on at least one of said first platform or support means and a slot in at least one of said first platform or support means or in said second platform, said member and the or each said slot being spaced from a pivot axis of the first platform, and the member being locatable in and out of the or each said slot and abutting on a side of the or a said slot when the second platform is in a retracted position.

The ramp may be so arranged that said member and/or the or each said slot is/are adjacent to said end of the first platform when the second platform is in a retracted position.

Said engaging means may comprise at least one lateral flange or member on said second platform, a first slot in a side of said support means and a second slot in a side of the first platform, said second slot being spaced from a pivot axis of the first platform, in a raised state of the first platform said first and second slots being substantially alongside one another and being enterable by said member on the retracted second platform for said member to rest on a lower side of the first slot whereby the platforms are supported in the raised state. The lower side of the first slot may comprise an obstruction to inadvertent disengagement of the member from the first slot.

A ramp may be formed according to any combination of the first and second aspects of the invention.

The ramp may be mounted on a vehicle for use in giving access thereto.

The first platform may be pivotably mounted on a or the support means, and fluid pressure actuated force applying means may be arranged to act, under fluid pressure, between said support means and the first platform to cause the first platform to pivot so as to lift a or the end of the first platform from which end the second platform is extensible.

Such a ramp may be constructed in which the provision of said fluid pressure actuated force applying means is as a very compact arrangement occupying a relatively small amount of space.

The fluid pressure actuated force applying means may comprise fluid pressure actuated jack means having a dimension which varies under fluid pressure causing said end of the first platform to lift.

If desired, the jack means may be a piston and cylinder with a rod actuated by the piston extending from one end of the cylinder, and said variable dimension of the jack means may be a variable length of the rod extending beyond said cylinder.

Alternatively, the fluid pressure force applying means may comprise a chamber or bag which expands under fluid pressure applied thereto.

Said end of the first platform may be a first end opposite to a second end of the first platform which may be pivotably mounted at or adjacent to said second end on the support means so as to pivot about a substantially horizontal axis, and the fluid pressure actuated force applying means may act under fluid pressure along a platform lifting line of action at a vertically different height to the pivot axis.

Said platform lifting line of action may be generally horizontal.

The platform lifting line of action may be below the pivot axis.

If desired, one of the cylinder or rod of the jack means may be secured to the first platform, and the other of the cylinder or rod of the jack means, under fluid pressure, thrusts against the support means.

A fluid pressure supply system can supply fluid to said fluid pressure actuated force applying means, and fluid pressure sensing means may be provided to observe when the pressure of the fluid supplied to said force applying means increases to a pressure at least equal to a pre-determined value.

The first platform may be lowerable under the force of gravity consequential to a reduction in fluid pressure applied to the fluid pressure actuated force applying means.

Damper means may be provided to oppose the affect of gravity and control the lowering of the first mentioned platform. The damper means may comprise at least one spring arranged for spring energy stored therein to be increased during lowering of the platform(s).

The aforesaid fluid pressure may be hydraulic pressure or pneumatic pressure.

The invention will now be further described, by way of example, with reference to the accompanying drawings in which:

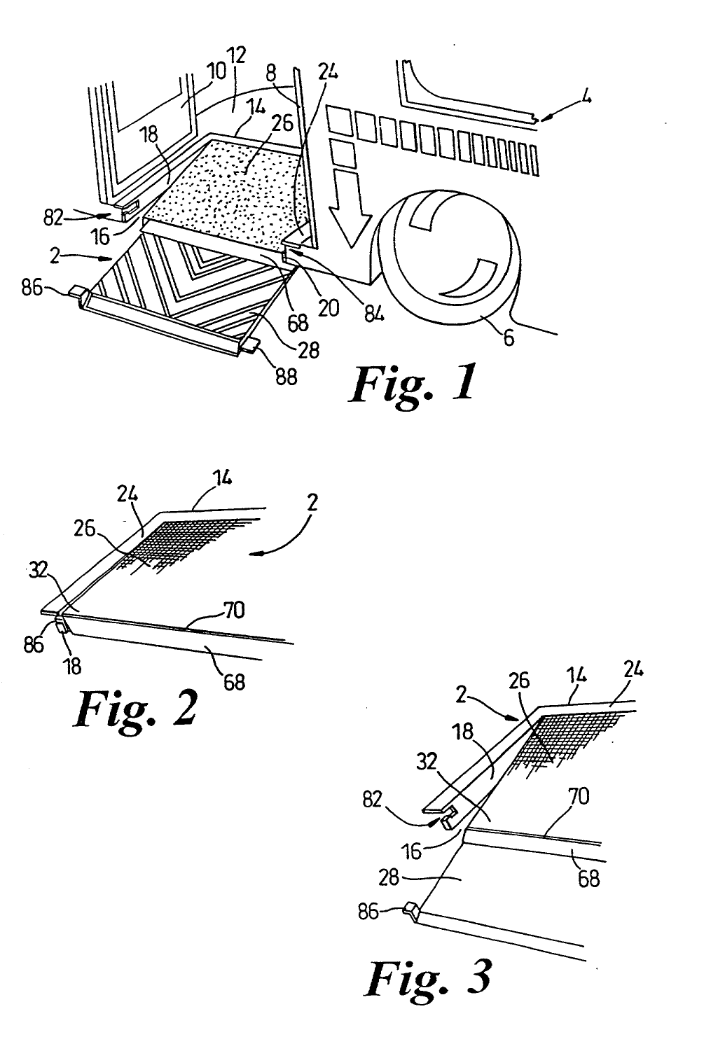

FIG. 1 shows a fragment of a passenger bus provided with a ramp formed according to the invention;

FIG. 2 shows a fragment of the ramp in FIG. 1 in a raised and retracted position;

FIG. 3 shows a fragment of the ramp in FIG. 1 in a lowered and extended position;

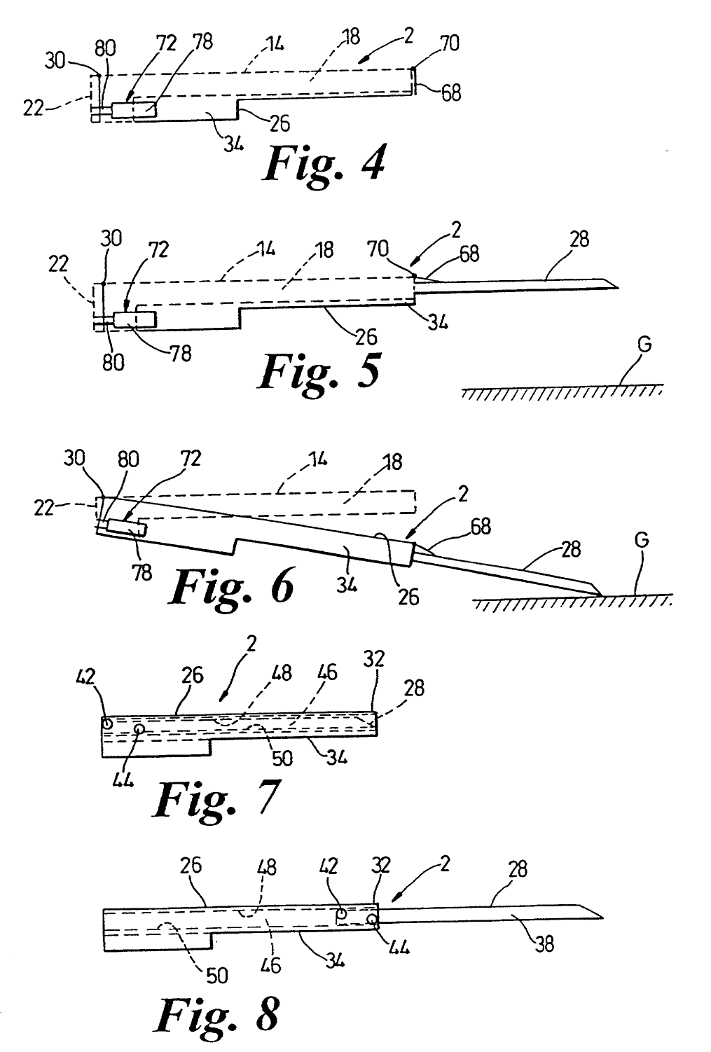

FIGS. 4, 5 and 6 are diagrammatic illustrations of the ramp in FIG. 1 in respectively a raised and retracted state, a raised and extended state, and a lowered and extended state;

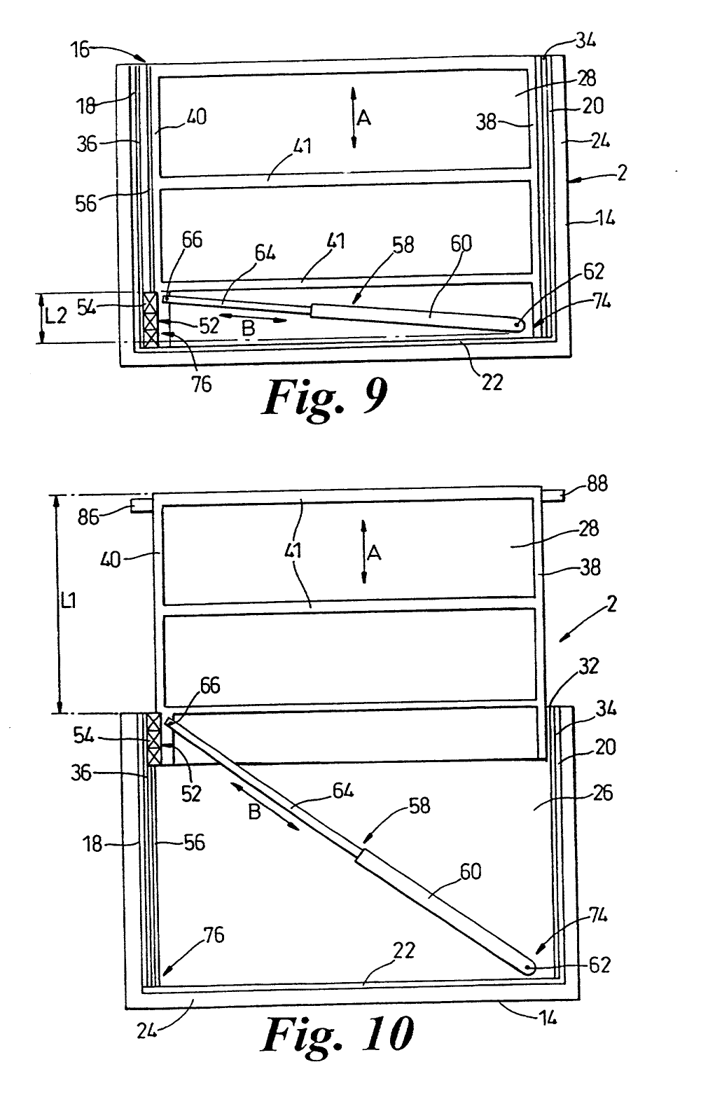

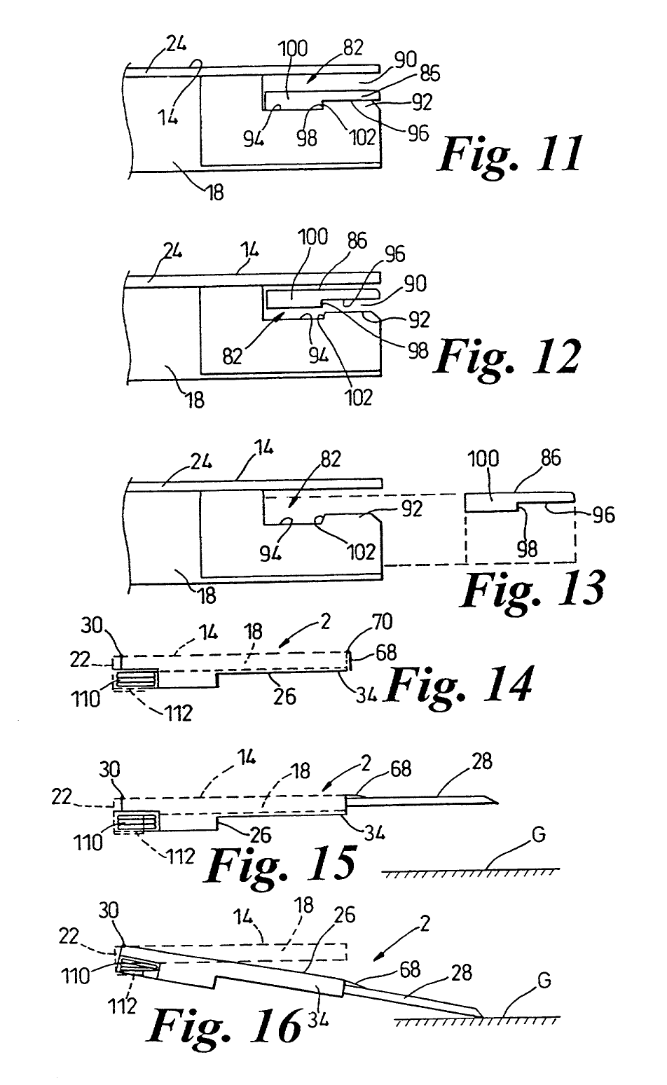

FIGS. 7 and 8 are diagrammatic illustrations comparable to FIGS. 4 and 5 of the ramp in FIG. I showing a bearing arrangement at one side of the ramp;

FIG. 9 is a diagrammatic inverse plan view of the ramp in FIG. 1 in a raised and retracted position;

FIG. 10 is a view similar to FIG. 9 but showing the ramp in an extended state;

FIGS. 11, 12 and 13 are diagrammatic illustrations of engaging means for supporting the ramp in FIG. I in a raised and retracted position, the Figures showing respectively the engaging means engaged, in an act of disengagement, and disengaged, and

FIGS. 14, 15 and 16 are similar to FIGS. 4, 5 and 6 respectively and diagrammatically illustrate alternative means for raising the ramp.

In the drawing like references identify like or comparable parts.

With reference to the drawings, and particularly FIG. 1, an access ramp is shown at 2 in an extended lowered state and provided on a vehicle 4, in this instance a passenger bus, having wheels 6 and a passenger entrance doorway 8 closable by a door 10. At the doorway 8 is a passenger entrance area floor 12 in which the ramp 2 is provided to allow wheelchair users (and others having difficulty walking) an easier access to or exit from the vehicle 4.

With reference to FIGS. 1 to 13, the ramp 2 comprises a U-shaped supporting frame 14 (represented in dotted lines in FIGS. 4 to 6) of a rectangular shape in plan having an open front end 16, two vertical side walls 18, 20, a vertical rear wall 22 and an horizontal surrounding flange 24 for insetting into or overlaying edges of a hole in the floor 12 containing the ramp 2. The frame 14 is secured in place in the floor 12 so as to be attached firmly to a chassis or sub-frame of the vehicle 4.

The ramp 2 further comprises two main platform parts 26 and 28 any of which may be covered with a suitable non-slip coating to give grip to wheels of wheelchairs and shoe soles. Platform part 26 is an elevating platform and platform part 28, which can extend telescopically from platform 26, is an extending platform.

As indicated in FIG. 4 to 6, elevating platform 26 (shown partially in full lines) is pivotably mounted at 30, at an upper part of its rear edge, on the supporting frame 14 so that the platform 26 can pivot about a substantially horizontal axis and thus raise or lower its front end 32.

Elevating platform 26 has a pair of vertical depending flanges or side walls 34 and 36. The extending platform 28 is disposed between the walls 34 and 36 and itself (see FIGS. 9 and 10) has two depending side walls 38 and 40 interconnected by reinforcing struts 41. Side wall 38 (see FIGS. 7 to 10) carries a pair of roller bearings 42 and 44 running in an open-sided rail or track 46 of a U-shape in cross-section in which one arm of the U forms an upper track wall 48 and the other arm of the U forms a lower track wall 50 parallel to the track wall 48.

The track 46 is mounted on an inside face of the side wall 34 of the platform 26. The roller bearings 42, 44 are each a roller wheel rotating on ball-bearings, the upper roller bearing 42 running on the inner surface of the upper track wall 48 and the lower roller bearing 44 running on the inner surface of the lower track wall 50. At the other side of the extending platform 28, and opposite to the bearings 42 and 44, is a linear bearing arrangement 52 mounted on the wall 40 of the extending platform. In this case the arrangement 52 comprises three linear ball bearings 54 extending around and running on a track or rail 56, which may be of circular cross-section, mounted on an inner side face of the side wall 36 of the elevating platform 26.

To move the extending platform 28 telescopically, on the bearings 42, 44, 52, relatively to the elevating platform 26, a double acting pressurised fluid powered piston and cylinder unit 58 is provided comprising a cylinder 60 pivotably mounted at 62 on the platform 26 and piston provided with a piston rod 64 pivotably mounted at 66 on the platform 28. In FIG. 9 the platform 28 is shown fully retracted and in FIG. 10 fully extended in which position the front end 32 of the platform 26 still overlies a rear part of the platform 28 with any gap between the two covered by a flap 68 (see FIGS. 1 to 6) hinged at 70 to the front end 32 and pushed into a slopping attitude by the extended platform 28. When platform 28 fully retracts, the flap 68 returns by spring and/or gravity force to the attitude in FIGS. 2 and 4 covering the open end of the platform 26 between its side walls 34, 36. The telescoping movement of the extending platform 28 is in the direction of double headed arrow A (FIGS. 9 and 10). The piston and cylinder unit 58 has its opposite ends attached respectively to the platforms 26 and 28 at substantially opposite respective rear corners of each. The line of action B, (FIGS. 9 and 10) of the unit 58 is transverse to the direction A of movement of the platform 28 and is at angle thereto greater than 0° but less than 90°. The stroke of the platform 28 is shown as L1 in FIG. 10. Because of the manner in which the piston and cylinder unit 58 is disposed in its “parked” position shown in FIG. 9, when the platform 28 is fully retracted, the unit 58 only occupies a length dimension L2 (FIG. 9) along direction A which dimension L2 is considerably shorter than L1 notwithstanding that the stroke of the unit 58 is relatively long. Thus the stroke L1 of the platform 28 is a plurality of times greater, for example more than three times greater, than the length L2 occupied by the piston and cylinder unit 58 in the “parked” position. Although the component of force exerted by the unit 58 along direction A is relatively small, the low friction bearing arrangements 42, 44, 52 compensate and allow easy adequate movement of the platform 28. In this respect we believe the use of the linear bearings 54 is particularly advantageous.

Though not shown in FIGS. 9 and 10, a respective, single acting fluid pressure operated piston and cylinder unit 72 (see FIGS. 4 to 6) is disposed adjacent to each rear corner 74, 76 of the elevating platform 26 between its side walls 34, 36; the platform 28 being able to slide over the units 72. Both units 72 each comprises a cylinder 78 and a piston thrust rod 80 having a rounded free end bearing on an inner face of rear wall 22 of the supporting frame 14 whilst the cylinder 78 is secured to the elevating platform 26. The line of thrust action of each rod 80 on the rear wall 22 is below the pivot axis of pivot 30, the line of thrust action being generally horizontal. When the units 72 are pressurised the resultant thrust on the wall 22 by the rods 80 causes the platform 26 to rise until it is in a substantially horizontal attitude (see FIG. 2 and 4). When the pressure in the units 72 is allowed to decrease, preferably at a controlled rate, the weight of the platforms 26, 28 causes the ramp 2 to pivot downward under gravity to lower it. This has the effect of pushing the thrust rods 80 further into the cylinders 78. If desired damper means (not shown) may be provided to counteract the effect of gravity during ramp lowering so it descends gently. The damper means may comprise one or more compression springs each braced between the rear wall 22 and a mounting point on the platform 26 whereby the lowering platform 26 causes the spring(s) to compress to increase the stored spring energy whereas a rising platform 26 allows the spring(s) to expand.

With particular reference to FIGS. 1 to 3 and 11 to 13, a similar notch or slot 82 or 84 is formed in the front end of the supporting frame side wall 18 or 20. Similar lugs or side flanges 86 to 88 extend laterally from the front end of the extending platform 28. Each slot 82, 84 has a relatively narrow entrance mouth 90 defined between the surrounding flange 24 and a lip portion 92 in the side wall 18 (20), said mouth leading into a wider rebated or notch portion 94 of the slot. Each side flange 86, 88 is thinned by a rebate 96 in its underside forming a shoulder 98 on the flange underside at a vertically thickest part 100 of the flange. Horizontal front slots (not shown) are each formed in a respective side wall 34, 36 of the elevating platform 26 such that the front slots coincide with the slots 82, 84 when the elevating platform is raised to its normal “parked” position, said horizontal front slots may be similar to the slots 82, 84.

When the elevating platform 26 is raised into substantially its highest position at which the front slots on the elevating platform coincide with the corresponding slots 82, 84 in the supporting frame 14 and the extending platform 28 is retracted substantially fully, the side flanges 86, 88 enter the respective slots 82, 84 and the front slots of the elevating platform so the position is as shown in FIG. 12. When the force causing the elevation of the platform 26 is removed, the telescoped platforms 26, 28 pivotably drop slightly at the front end 32 causing the undersides of the flanges 86, 88 to rest on lower sides of the slots 82, 84 (see FIG. 11), the flange parts 100 being in the notch portions 94 with flange shoulders 98 engaging lip edges 102 to prevent inadvertent forward displacement of the retracted extending platform 28. Accordingly in the “parked” position of the ramp 2 (FIGS. 2, 4, 7, 9 and 11), both platforms 26, 28 are entirely supported by the pivot 30 and by the flanges 86, 88 resting on the lower sides of the slots 82, 84, the elevating platform 26 resting on upper faces of the flanges 86, 88. To release the flanges 86, 88 from the notches 82, 84 the elevating platform 26 is raised slightly so lifting the retracted platform 28 that the flanges 86, 88 lift from the position in FIG. 11 to that in FIG. 12. Then the platform 28 is telescoped out so the flanges 86, 88 leave the slots for a position such as shown in FIG. 13.

An operation of the ramp 2 will now be described in which the piston and cylinder units 58, 72 are operated by hydraulic pressure developed in an hydraulic pressure supply and control system (not shown). Starting with the ramp 2 in its “parked” position i.e. the elevating platform 26 being raised to nearly its uppermost level and the platform 28 being fully retracted the procedure to lower the ramp 2 to ground G (FIGS. 5 and 6) from the “Parked” position in FIGS. 2, 4, 7, 9 and 11 is as follows after setting the hydraulic supply and control system in operation:

(i) the two piston and cylinder units 72 are pressurised causing thrust rods 80 to push on the rear wall 22 so that the elevating platform 26 is pivoted up slightly (FIG. 12) about pivot 30 until to comes against first stop means (not shown) and can pivot no further so the hydraulic pressure in the units 72 continues to rise until it reaches a pre-determined first value, for example 45 bar, observed by a first pressure sensor (not shown) causing the system to operate so that,

(ii) the double acting piston and cylinder unit 58 is supplied with hydraulic pressure causing it to extend the extending platform 28 to its maximum position beyond front end 32 of the platform 26 (see FIGS. 5, 8 and 10) where it is stopped by second stop means (not shown), so the hydraulic pressure in the unit 58 continues to rise until it reaches a pre-determined second value, for example 5 bar, observed by a second pressure sensor (not shown), whereupon the system operates to,

(iii) dump the hydraulic pressure in the units 58 and 72 so that as the pressure dumps from units 72 the extended ramp 2 pivots down to ground G under gravity into the attitude in FIGS. 2, 3, 6 by reason of the reducing thrust exerted by the thrust rods 80.

To lift and retract the ramp 2 the supply and control system:

(I) supplies hydraulic pressure to the units 72 causing the thrust rods 80 to push on wall 22 thereby pivoting the extended ramp 2 upwards about the pivot 30 (to substantially the position in FIGS. 5 and 8) until stopped by said first stop means whereupon the pressure continues to rise until the first pressure sensor observes attainment of a pre-determined value, for example said first pre-determined value, at which the control system is caused to,

(II) supply hydraulic pressure to the piston and cylinder unit 58 which retracts the platform 28 into the platform 26, until stopped by third stop means (not shown), to substantially the position in FIGS. 4, 7 and 9 whereupon the pressure in the unit 58 continues to rise to a pre-determined value, for example to said second pre-determined value, at which the control system is caused to,

(III) dump the hydraulic pressure in the units 58, 72 (thrust on rods 80 drops) whereupon the telescoped ramp 2 pivots down slightly to the “parked” position shown in FIGS. 2 and 11 where the flanges 86, 88 engage with the slots 82, 84 to support the telescoped ramp.

Instead of the units 58 and 72 being hydraulic, they may be operated by pneumatic pressure. This would be convenient where the ramp 2 is on a vehicle provided with a pneumatic pressure system, for example a pneumatic braking system.

In the modification shown in FIGS. 14 to 16 the units 72 in FIGS. 4 to 6 are replaced by one or more expandable pneumatic bags or chambers 110 acting between a stationary floor part or flange 112 (which may be part of a vehicle chassis, sub-frame or part of the supporting frame 14) and a rear end part of the elevating platform 26. The pneumatic force applicator(s) 110 act generally vertically to one side of the axis of the pivot 30. When the pneumatic pressure is dumped the chamber(s) 110 deflate allowing the ramp 2 to pivot down as in FIG. 16. But when the force applicator(s) 110 are pressurised the resultant force pivots the ramp 2 upwards to its raised position as indicated in FIG. 15 or FIG. 14.

As suggested by FIG. 4 to 6 or FIGS. 14 to 16 the selection of fluid pressure operated units 72 or force applicator(s) 110 to provide platform and ramp raising force and to control ramp lowering, means that a very compact arrangement of the units 72 or applicator(s) 110 is possible.

Also the use of unit 58 admits a compact arrangement to move platform 28.

1. A ramp to give access comprising a raisable and lowerable first platform, a second platform extensible from the first platform beyond an end of the first platform and retractable relative to said first platform, fluid pressure force exerting means arranged to act, under fluid pressure, between first and second platforms to extend or retract the second platform along a first line of action, and said fluid pressure force exerting means being arranged to act along a second line of action which is transverse to the first line of action.

2. A ramp as claimed in claim 1, in which the fluid pressure force exerting means comprises a fluid pressure actuated piston and cylinder unit.

3. A ramp as claimed in claim 2, in which the unit is pivotally mounted on the platforms.

4. A ramp as claimed in any one preceding claim, which a length of a stroke of the second platform relative to the first platform along the first line of action corresponding to a full extension or full retraction of the second platform with respect to the first platform is a plurality of times greater than a length dimension along the first line of action occupied by the fluid force exerting means in a parked position when the second platform is fully retracted.

5. A ramp as claimed in claim 4, in which said length of the stroke is more than three times greater said length dimension.

6. A ramp as claimed in any one preceding claim, in which the second platform moves relatively to first platform on bearing means between the platforms.

7. A ramp as claimed in claim 6, in which aforesaid bearing means between the platforms at or adjacent to a side of each platform comprises at least one linear bearing.

8. A ramp as claimed in claim 6 or claim 7, in which aforesaid bearing means between the platforms at or adjacent to a side of each platform comprises a roller running on track or rail means.

9. A ramp as claimed in any one preceding claim, in which the raisable and lowerable first platform is pivotably mounted on support means, and engaging means being operable in a retracted position of the second platform to support the platforms in a raised state on said support means.

10. A ramp as claimed in claim 9, in which said engaging means comprises a member on one of said second platform or on at least one of said first platform or support means and a slot in one of said first platform or support means or in said second platform, said member or the each said slot being spaced from a pivot axis of the first platform, and the member being locatable in an out of the or each said slot and abutting a side of the or a said slot when the second platform is in a retracted position.

11. A ramp as claimed in claim 9, in which said engaging means comprises at least one lateral flange or member on said second platform, a first slot in a side of said support means and a second slot in a side of the first platform, said second slot being spaced from a pivot axis of the first platform, in a raised state of the first platform said first and second slots being substantially alongside one another and being enterable by said member on the retracted second platform for said member to rest on a lower side of the first slot whereby the platforms are supported in said raised state.

12. A ramp as claimed in claim 11, in which a lower side of said first slot comprises an obstruction to inadvertent disengagement of the member from the first slot.

13. A ramp as claimed in any one of claim 1 to 12, in which the ramp is to be mounted on a vehicle for use in giving access thereto.

14. A ramp as claimed in any one preceding claim in which the first platform is pivotably mounted on a or the support means, and fluid pressure actuated force applying means being arranged to act, under fluid pressure, between said support means and the first platform to cause the first platform to pivot so as to lift a or the end of the first platform from which end the second platform is extensible.

15. A ramp as claimed in claim 14, in which the fluid pressure force applying means comprises fluid pressure actuated jack means having a dimension which varies under fluid pressure causing the end of the first platform to lift.

16. A ramp as claimed in claim 14, in which the fluid pressure force applying means comprises a chamber or bag which extends under fluid pressure applied thereto.

17. A ramp as claimed in claim 14, in which said end of the first platform is a first end opposite to a second end of the first platform which is pivotably mounted at or adjacent the second end on said support means so as to pivot about a substantially horizontal axis, and the fluid pressure actuated force applying means acts under fluid pressure along a platform lifting line of action at a vertically different height to the pivot axis.

18. A ramp as claimed in any one of claims 14 to 17, in which the first platform is lowerable under the force of gravity consequential to a reduction in fluid pressure applied to the fluid pressure actuated force applying means.

19. A ramp as claimed in any one preceding claim, having damper means to oppose the affect of gravity on the platforms and control the lowering of the first platform.

20. A ramp as claimed in any preceding claim, in which said fluid pressure is hydraulic pressure or pneumatic pressure.

21. A vehicle provided with a ramp as claimed in any one preceding claim to give access to the vehicle.
